(19) United States
(12) Patent Application Publication
(10) Pub. No.: US 2007/0282673 A1
(43) Pub. Date: Dec. 6, 2007

(54) Method and system for implementing portal

(75) Inventors: Ajay Nagpal, Short Hills, NJ (US); Ken Umezaki, New York, NY (US); Roben Dunkin, Glen Ridge, NJ (US); Vinod Vallabhaneni, Hoboken, NJ (US); Yuriy Chernyshenko, Staten Island, NY (US); Terry Leung, Edison, NJ (US); Mohammed Ishaq Syed, Jersey City, NJ (US)

Correspondence Address: Daniel H. Golub, 1701 Market Street, Philadelphia, PA, 19103, US

(73) Assignee: Lehman Brothers Inc., New York, NY (US)

(21) Appl. No.: 11/796,918

(22) Filed: Apr. 30, 2007

Related U.S. Application Data
(60) Provisional application No. 60/796,334, filed on Apr. 28, 2006.

(51) Int. Cl. G06Q 10/00; G06F 17/18; G06F 3/14

(52) U.S. Cl. 705/11; 715/700

(57) ABSTRACT

The present invention is directed to a system and method for displaying sales information to a sales person via a portal. Data from a plurality of data sources is aggregated. Sales credit information attributable to the sales person for his clients, and for products associated with one or more of such clients, is identified. Based on (i) user profile information for the sales person, (ii) at least some of the aggregated data, and (iii) at least some of the identified sales credit information, sales strategy information is generated for the sales person. Content of the portal is generated based on the sales strategy information.

### CROSS REFERENCE TO RELATED APPLICATIONS

This application claims priority to U.S. Provisional Patent Application No. 60/796,334, filed Apr. 28, 2006, which is incorporated herein by reference in its entirety.

### FIELD OF THE INVENTION

The present invention relates to methods and systems for implementing a portal.

### BACKGROUND OF THE INVENTION

Constituents of organizations in many types of industries, and the financial services in particular, require near-constant access to data of a variety of different types, originating from a variety of different data sources, in order to perform their jobs. Gaining adequate access to this data can prove challenging, in that data sets may be incomplete, or housed in separate silos thereby providing limited ability to evaluate such data without manual intervention. Similarly, reporting of data within such organizations may not be standardized. The data reporting framework may be inconsistent because it is performed by various groups. Finally, data that is the subject of such reports is static, thereby requiring multiple, independent systems to generate single-point in time snapshots of the same. Thus, there is a need in the art for a system and method for providing improved access to data and consistent reporting of the same.

### SUMMARY OF THE INVENTION

The present invention is directed to a system and method for displaying sales information to a sales person via a portal. Data from a plurality of data sources is aggregated. Sales credit information attributable to the sales person for his clients, and for products associated with one or more of such clients, is identified. Based on (i) user profile information for the sales person, (ii) at least some of the aggregated data, and (iii) at least some of the identified sales credit information, sales strategy information is generated for the sales person. Content of the portal is generated based on the sales strategy information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1A is an exemplary hardware diagram that may be used to implement a preferred embodiment of the present invention;

FIG. 1B is an exemplary architecture diagram illustrating a preferred embodiment of a system of the present invention;

FIG. 1C is a diagram of an exemplary application framework that may be used in connection with a preferred embodiment of the present invention;

FIG. 2 is a diagram showing an exemplary flow of data in connection with personalization of the portal in accordance with a preferred embodiment of the present invention;

FIGS. 3A, 3B, and 3C are exemplary screen shots that may be used in connection with a trader portal in accordance with a preferred embodiment of the present invention;

FIGS. 4A, 4B and 4C are exemplary screen shots that may be used in connection with a sales portal in accordance with a preferred embodiment of the present invention;

FIG. 5 is a exemplary screen shot illustrating a attributed coverage system matrix; and

FIG. 6 illustrates an exemplary method for displaying sales information to a sales person via a portal.

### DETAILED DESCRIPTION OF THE PREFERRED EMBODIMENTS

The portal described herein provides a single site where individuals can gain access to information and data necessary to conduct their business. A comprehensive data set, accessible across multiple dimensions is provided. The data is accessible from a single point (i.e., through the portal), but observable from multiple points of view, depending on the role of the user. Data is housed in a consistent fashion, with built-in reconciliation checks. Real-time monitoring of certain data metrics may also be included.

Many aspects of the portal described herein can be used within any type of organization/type of business and, thus, the invention is not limited in that sense. However, the portal is specifically useful within the financial services industry and certain exemplary embodiments are described herein with reference to the financial services industry.

For example, in the financial services industry, the portal may provide a “one-stop-shop” for internal management information. It may provide access to all levels of position and risk management information; provide tools for resource management, strategic planning and client development; and provide the ability to data mine and build reports. Users may include managers, desk heads and other appropriate staff, providing access to multiple functional groups such as sales, trading, research, origination and structuring. Appropriate security is provided, in that access to data is controlled on an individual basis.

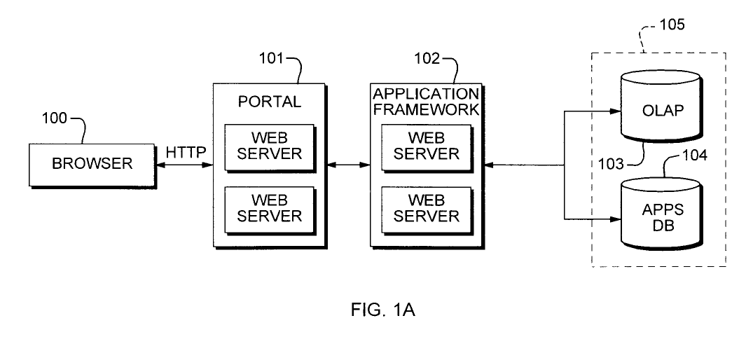

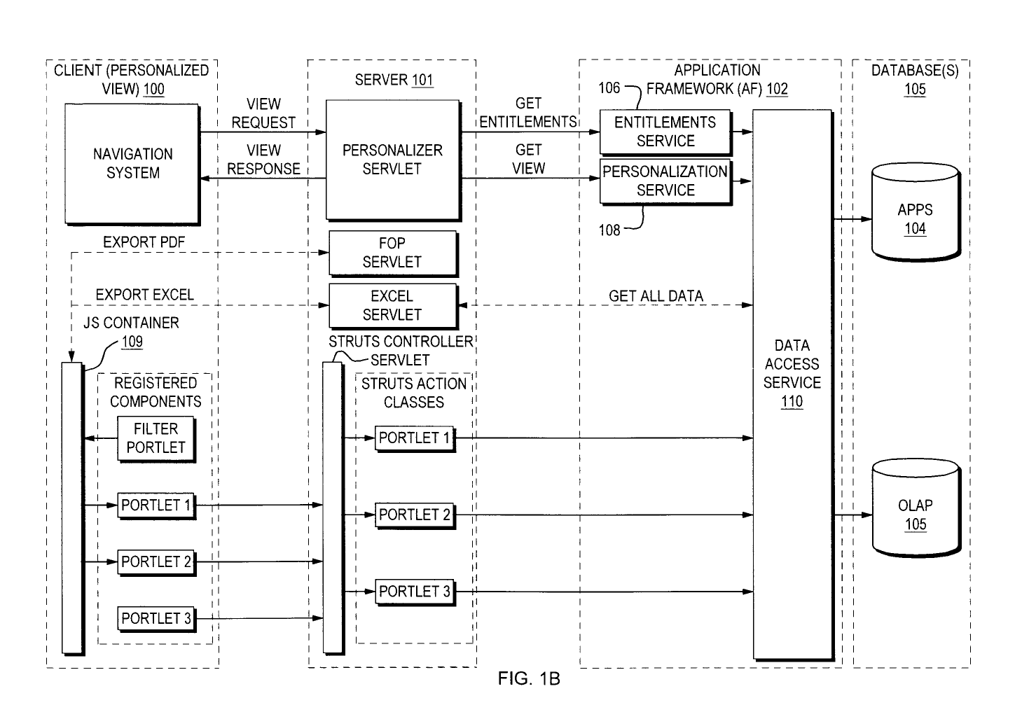

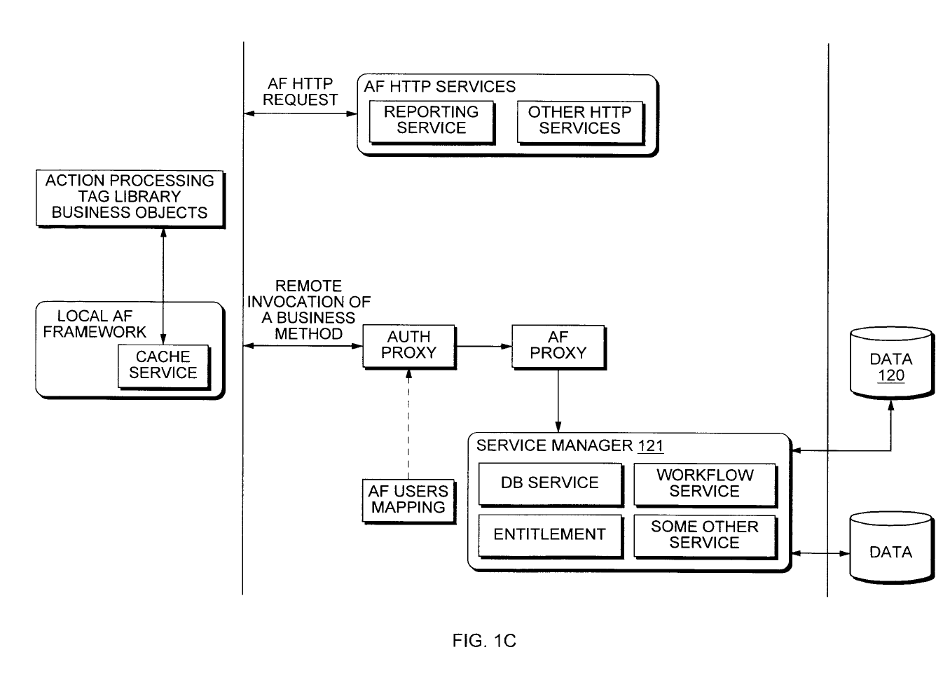

With reference to FIG. 1A, an exemplary hardware diagram for implementing a system of the present invention is illustrated. A user may employ browser 101 to access application framework 102, through the portal 100, comprised of one or more web servers. Databases 105 (comprising database 103, which stores quantitative data such as revenue information and database 104, which stores qualitative data such as personal setting information) may be used to store data generated in connection with such user's use of the system.

With reference to FIG. 1B, an exemplary system architecture diagram is illustrated. The architecture of the portal includes of four primary components: databases 105, application framework 102, server 101, and client 100. The information that is being transported from the databases 105 to the users at client 100 includes revenue, user profile and preferences information. Databases 105 are represented by both OLAP (Online Analytical Processing) database 103 and apps database 104. The OLAP database 103 is used to provide quick response time on complex queries and large aggregations on revenue data. The core responsibility of apps database 104 is to store the users' profiles and preferences. Application framework 102 is implemented in Java, in one embodiment, and the core function is to provide a suite of reusable services (e.g., personalization services 108, entitlement services 106, database services 110, etc.). These services expose business oriented functions and hide the technical details. The interaction between the databases and these services is via JDBC, in the illustrated embodiment. The server component is a model controller (i.e., server 101), which is a collection of server side classes. The main responsibility of these classes is to bridge the application framework 102 and user interface framework 100. The communication between the application framework 102 and the model controller 111 are via either native http requests or by remote invocation method. The client experience is maintained through a user interface framework. This framework utilizes Ajax (Asynchronous JavaScript and XML) to enhance the user experience and it provides a library of client-side functionalities to be shared and reused by all portlets within the portal. The communication between the model controller 111 and client browser 100 is via http requests.

With reference to FIG. 1C, the application framework 102 is described in more detail. This diagram provides an in-depth look of the Application Framework. The information that is being transported from the data source 120 to the service consumers is revenue, users profile and preferences. Data Source 120 represents the databases 103 and 105 from FIG. 1B. The service consumer represents the model controller 111 from FIG. 1B. The service manager 121 within the application framework is reusable for both portal and other applications. These services include database, workflow, entitlement and others. To access these services via the remote invocation method, it has to go through both AF Proxy and Auth Proxy. To access these services via http requests, it will have to go through http services in order to be able to access to the service manager 121.

The application framework is comprised of a number of layers, in one exemplary embodiment. The controller layer first receives an HTTP request from a client and determines if the environment should be initialized. This layer also contains the action controller, security filters and data validation, and the action dispatcher. The action controller regulates the user request and is a single entry point for the application in order to process all requests. It creates and stores an action exceptions object in the HTTP request. It executes the request filter manager to perform any request filtering, and forwards requests to the action dispatcher. The action dispatcher interacts with the model layer to process a request and interacts with the view layer to dispatch the result. It is responsible for the command mapping process. It forwards requests to the service manager. The content generator massages the content that the action dispatcher dispatches. The main function of the content generator is to lookup the workflow and the type of response, process the content, and prepare a content model that is returned to the client. The request filter manager and request filter manipulate incoming requests and outgoing responses. These components act to map a requested URL to a particular command and act as an interface to different services. The model layer contains the service and business objects managers, as well as several application elements, data oriented controllers, objects and the data source. The service manager is responsible for managing the lifecycle of core and business services. It initiates a service request, receives a result and sends back the response. It can act as a service provider for external systems. The business object manager is responsible for managing the life cycle of business objects. It acts as a liaison between the service manager and the business services. It is used to locate a business object. The business object performs actual business functions and returns the result of the business object manager. It implements business rules. The data access component prepares the data processing operation with user inputs from the business object and forwards the request to a business service to perform the operation. It encapsulates the finer details of the data processing operation for a business object. The view layer contains the client oriented elements, such as the JSP Content Model and the XSL Content Model. This includes view components such as JSP and XSL. JSP rendering is performed on the server side; XSL rendering can either be performed on the client or server side.

The following describes some features of and embodiments provided by the portal, one or more of which may be present in any particular embodiment thereof.

For organizations that offer use of multiple applications to their constituents, owners of such applications are required to manage each user's level of access to different applications, as well as to content within those applications. Managing access to multiple applications can quickly become burdensome, particularly if each application is driven by a different source.

A security entitlements layer (component 106 FIG. 1B and entitlement service 107 of FIG. 1C) can be used to centralize access to separate applications. User entitlements and the user profile are retrieved at initial entry to the application. This user profile is then carried through all applications the user accesses. This allows a seamless flow from one application to another. Also, it standardizes user roles and how users access the system. A security entitlements database 104 contains full user profile information such as email address, employee's manager, department, and login ID, by way of example. This database contains roles to all applications to which the user has access. This service can also be used to configure/restrict the data the user can access. For example, a user can be set up as a Branch Manager, with access only to specific branches.

It is common in many applications to specify generic user roles, such as manager roles and salesperson roles. Such roles may determine the portlets viewable to the user, as well the placement of the portlets within the application. These roles are rigid in the sense that any addition, removal or modification of portlets would be seen across a user role. Any changes made to the layout of a user role would have to be made in the source code. Also, from a user perspective, information visible to the user may not be relevant to the user's business. Conversely, information that is the most important to the user'business may not be easily accessible.

To alleviate these problems, a personalization component (component 108 of FIG. 1B may be implemented. This component includes a personalization database, an admin tool, and a personalization runtime engine, in one embodiment. In lieu of changing source code to alter portlet placement within an application, application users can use the personalization admin tool. Within the personalization admin tool, users have access to all portlets that were entitled to them. Based upon a user preference, users can decide which portlets would be visible and where the portlets would be placed on the initial application screen. Users can also create multiple layout screens to display different portlets.

Users can also use the layout from their default user role that was created by their adminstrator. Instead of generic user roles found in legacy applications, administrators can create user roles that are specific to the business they support. Administrators can manage and configure the portlets viewable to that particular user role.

Thus, users can create personalized pages based on the user's role and his/her preference. Once the user create/selects his/her custom view, the information is stored in a database and, when the user requests this page at run time, the page is rendered dynamically based on the information stored in the database by the admin tool.

The personalization service includes three high level modules, in a preferred embodiment. The portlet pre-configuration module is used by developers to enter information about such components in a database. The component information (such as name of the resource, URL, the default height and width, the user roles that can access this particular component) is stored in the database using this tool. The data entered by this tool is used as reference data by the user admin tool and the page generation module during creation of the personalized template for the user and during rendering of the page, respectively.

The user admin tool is used by the user to personalize the web page he wants to view. This tool uses the reference data about the components entered using the pre-configuration module to present the user with the components that can be viewed by the particular user role. The users then pick the components and place them on his view customization template at the position of his choice. The user is required to select certain required components based on the role and the other optional components can be selected based on the user's preference. The user can drag and drop each component on the view template and place each at its location of preference. Once the user is satisfied with the customized view he wants, he can then save this customization using the admin tool. When user saves the configuration, the admin tool calculates the position of each component elected by the user and saves it in the database. This information is used by the page generation module during rendering of the personalized page at run time. The admin tool saves the X and Y co-ordinates of the portlet as well as the height and width of the portlet on the page.

The page generation module is used to render the HTML pages dynamically when the user requests his personalized page. When the page is requested by the user, based on the application and the user information, this module retrieves the personalization information from the database. This information contains the components selected by the user to be displayed on the personalized view and the information regarding the positioning of each of these components in the HTML page. In one implementation, for each component, a div HTML tag is generated with an enclosed iframe tag with height and width of the component at the absolute position calculated for this portlet by the admin tool. For example:

```
    <DIV name=“f” style=“BORDER-RIGHT: black 1px solid;
BORDER-TOP: black 1px solid; Z-INDEX: −1; LEFT: 20px;
BORDER-LEFT: black 1px solid; WIDTH: 372px; BORDER-BOTTOM:
black 1px solid; POSITION: absolute; TOP: 36px; HEIGHT: 52px”>
    <iframe height=52 width=372 src=“Hello.html”
    scrolling=no></iframe></DIV>
```

As can be seen in the example above, the generated div tag contains the left, top, height and width attributes with the values calculated by the admin tool when the user personalized the view. Also, the iframe tag enclosed in the div tag has the height and width attributes calculated by the admin tool.

Once the div tags are generated for each of the components selected by the user, these tags are added to a pre-defined html template as shown in the example below:

```
  <html>
  .....
  <body>
  ......
  <DIV name=“f” style=“BORDER-RIGHT: black 1px solid;
BORDER-TOP: black 1px solid; Z-INDEX: −1; LEFT: 20px;
BORDER-LEFT: black 1px solid; WIDTH: 372px;
BORDER-BOTTOM: black 1px solid; POSITION: absolute; TOP: 36px;
HEIGHT: 52px”>
  <iframe height=52 width=372 src=“Hello.html” scrolling=no></iframe>
  </DIV>
  ......
  </body>
  </html>
```

This dynamically generated HTML page is served to the user.

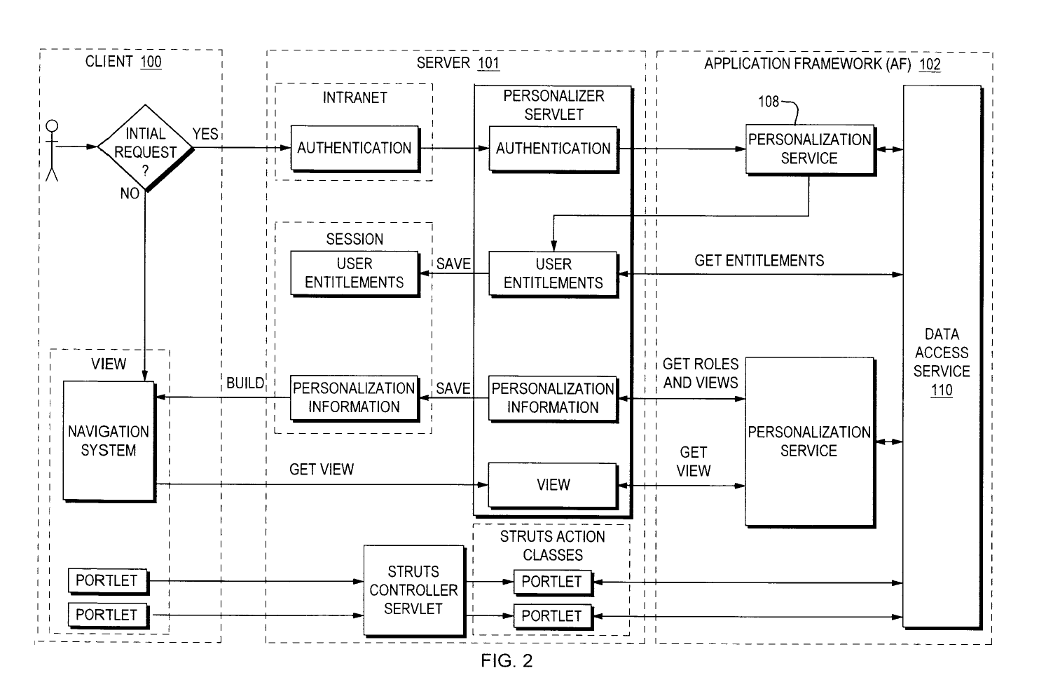

With reference to FIG. 2, an exemplary runtime diagram for accomplishing personalization of portlets in accordance with the system described herein is shown. This diagram illustrates the flow and interaction of each component within the portal architecture from the time a user enters the application. When a user enters the application, it will go through the initial request decision block. For the initial request, the model controller will gather the authentication, user entitlements and personalization information by invoking the services within the application framework. These services will collect the information from the apps database. After the authentication and preferences process completed, each porlet requests the struts controller servlet in the server. For each porlet, it will invoke the database service in application framework for the necessary revenue information.

Many users of applications accessible via the portal require the capability to generate a PDF report from each portlet. In known systems, in order to create the PDF report, the report generation software (e.g., Crystal Reports) was required to execute an additional call to the database to retrieve the same data that was being displayed on the user screen. In addition, changes made within the portlets by the user (such as, e.g., sorting, column rearranging, etc.) would not be reflected on the PDF report. Using such reporting software also required that any changes in the logic used to retrieve the data must be applied in two places, making the code more difficult to maintain.

In one solution implemented via the portal, PDF reports are generated using formatting objects processor (FOP) software, i.e., an XSL-FO processor written in Java, which provides the feature to convert XSL-FO files to PFD or direct-printable-files. First, the data within the portlet is converted to XML format. The XML data can then be converted to the final PDF report using XSL-FO templates. This approach eliminates the additional call to the database, which greatly improves response time. Also, it preserves the changes made within the portlet by the user.

In certain applications, data displayed by the individual portlets were driven by various parameters, such as sales force, salesperson, and region. These variable parameters are displayed in dropdowns on the page. The user selects the variable of interest from this dropdown to view the related information in each portlet on the page. In this approach, portlets were controlled centrally in the top level page. If there were a change in a parameter, the top level page would make a call to each portlet. Each time a portlet was added or removed, or if the logic of a portlet changed, this required a change to the central code that drives the portlets. Additionally, initiating one-to-one communication between two portlets on the page was difficult, as the portlets were managed centrally.

In one solution implemented via that portal, a JavaScript (also referred to herein as “JS”) framework (see JS container 109 of FIG. 1B) is implemented. This framework includes two lightweight JavaScript libraries that provide a much more flexible and scalable approach to portlet communication. With this new approach, each individual portlet is joined to the JS framework and registered to the container 109. Any registered portlet can inform the container about to change in its state. This information is communicated to the other portlets and the other portlets react accordingly. For example, when a parameter in a dropdown list is changed in one portlet, the other portlets that are affected make the corresponding change. The individual portlets can also acquire the handle of some other portlet on the page from the container and then instantiate one-to-one private communication with this portlet.

In one embodiment of the portal described herein, client-side code and functionality is standardized and centralized in common libraries. Code used in many portlets and screens can reside in one central location or library. Also, where possible, what may traditionally have been server-side functionality is moved to the client-side. Actions like sorting and generating PDF files are standardized and moved to the client-side to optimize performance.

As referenced above, the portal described herein has particular applicability in the financial services industry. Three exemplary embodiments are described herein for purposes of illustration—a sales portal, a trader portal and a fixed income portal. As will be apparent to those skilled in the art, the examples provided herein are not intended to be limiting, as the invention has applicability in many different contexts, both within and outside the financial services industry.

An exemplary trader portal is described as follows. The portal may be used to assist traders in connection with budgeting. With regard to budget planning, budget templates may be provided. Each business group may have different requirements with respect to the details that are collected during their budget periods. The system provides the user with a budget plan template that is appropriate to his business group and that supports the top-down/bottom-up budgeting process. Further, the system provides support for iterative budget planning. In particular, a user may provide details for only portions of his budget plan and then wish to come back and provide additional details at a later point in time. The system allows users to create, modify, review, etc. until they are satisfied with the details of their plan, at which point they can approve the plan, thus signaling to their manager that the details of their plan are ready for review. The management summary report makes it clear which traders have signed off on their numbers and which are still a work-in-progress. The system also provides the ability to attach a document (or set of documents) to a budget plan. In order to force users to provide succinct summaries for each of the budget plan areas yet still allow users to provide full/expanded detail where appropriate, the system allows the user to attach a document (or set of documents) to the budget plan. The attached document will be available for download/review by any user with access to the trader's budget plan.

The system allows for the rendering of a given budget plan to PDF. This is required in order to enable formatted printing as well as to allow the user to forward their budget plan via email and save it externally for future reference/review.

The system provides traders/managers with access to their current annualized numbers. These numbers are accessible to the user during the time that he is completing his next year budget in order to guide his forecasts.

With regard to reporting, drill-down reports with linkage to budget plans are provided. The system provides a summary management report that includes a user interface that intuitively models the account hierarchy and allows the user to drill into details as desired; control totals (top down), aggregate numbers (bottom up), and their differences (control total−aggregate) for Revenue, Sales Credits, and Balance Sheet; and linkage to the individual trader budget plans (allowing a user to negotiate the report from the top of the account hierarchy right down to the specific details of a trader's budget). The system also allows for exporting of management summary details to Excel. The exported data is in a raw format (no formatting) in order to allow further research/calculations to be undertaken in Excel. Security is provided on summary reports. These assignments are used to determine what a user can see when he displays the management summary report (i.e., a user can only see those details that are at or below the node to which the user is assigned, e.g., traders see only their numbers, managers see the numbers of all traders beneath them, etc).

A top-down/bottom-up aggregate comment field is provided for managers. The management summary report displays three separate numbers for each of Sales Credit, Revenue, and Balance Sheet: the control totals (top down), the aggregates (bottom up), and the difference between the two. In those cases in which the difference between the control totals and the aggregates require supporting details, the system provides the user with the ability to provide such details. This may take the form of an additional comment field in the manager's budget plan.

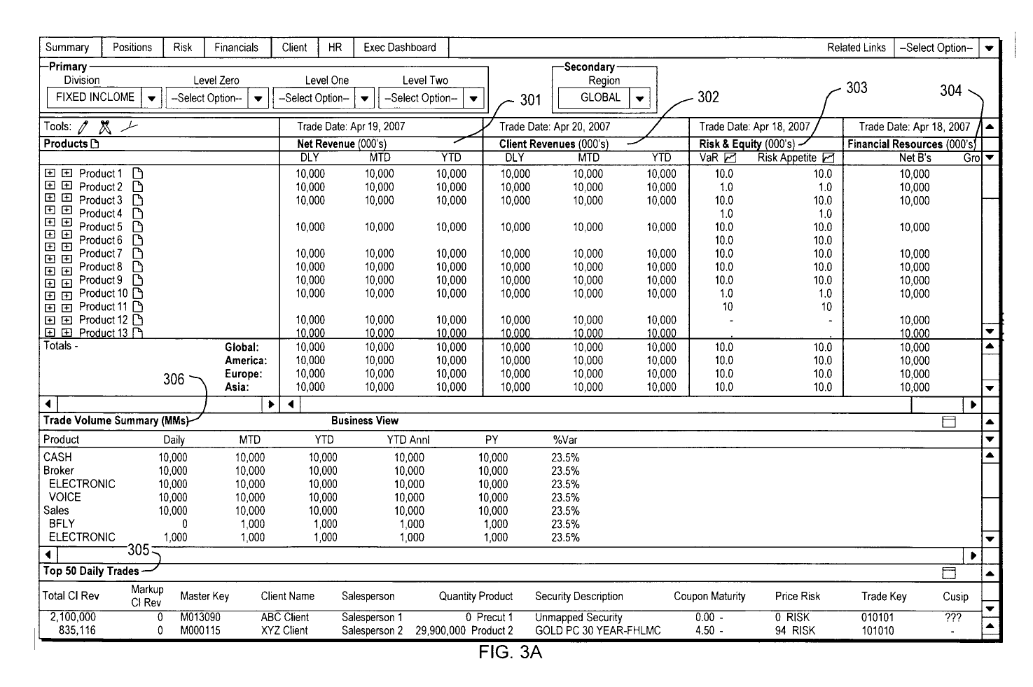

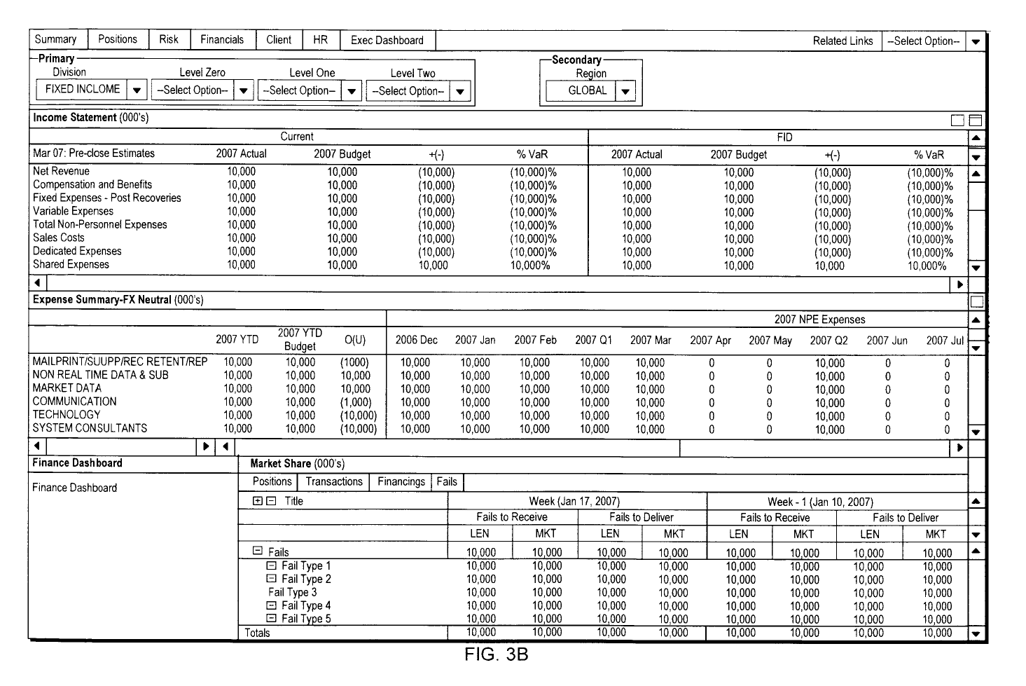

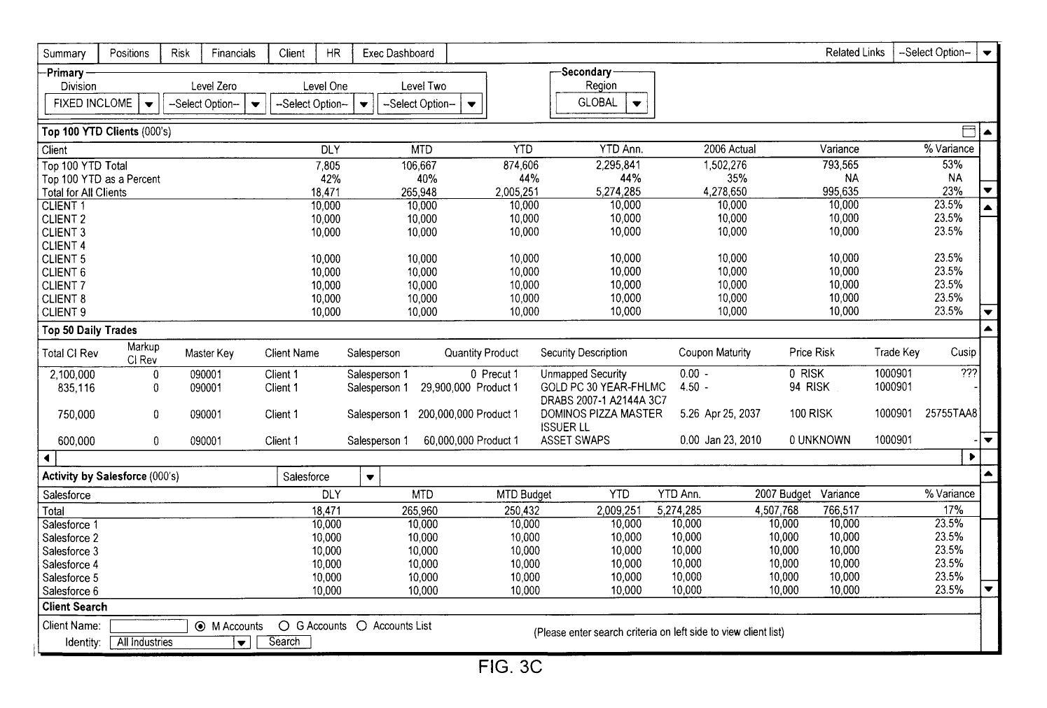

With reference to FIGS. 3A, 3B, and 3C, exemplary screen shots that may be used in connection with the trader portal are shown. With reference to FIG. 3A, the screen associated with the Summary Tab is shown. This screen provides users with access to daily, monthly, and YTD net revenues 301 (sourced directly from data available through the finance department of an organization); daily, monthly and YTD client revenues 302 (sourced directly from data available through the finance department of an organization); risk metrics 303 (sourced directly from data available through the risk management department of an organization); financial resources 304 (e.g., balance sheet cash capital, reg cap and associated limits) (sourced directly from data available through the finance department of an organization); top daily global client trades 305 (which may be linked to the sales portal, described in more detail below); and volumes 306, such as aggregated cash and derivative volumes. With reference to FIG. 3B, a screen representing a portion of the Financials Tab is shown. This screen provides access to a Financial Dashboard, showing the actual and budget non-personal expenses summary information. With reference to FIG. 3C, a screen associated with the Client Tab is shown. This screen provides users with access to client information. It is also linked to the sales portal, described in more detail below. Data from sources in addition to those listed here may also be made available through the trader portal on a periodic basis.

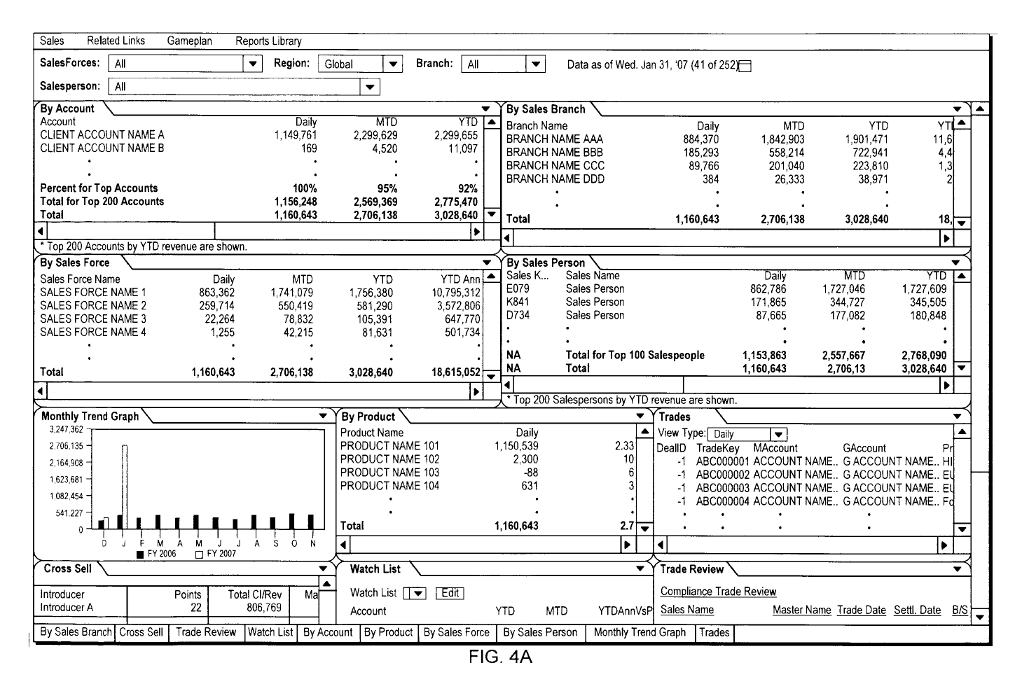

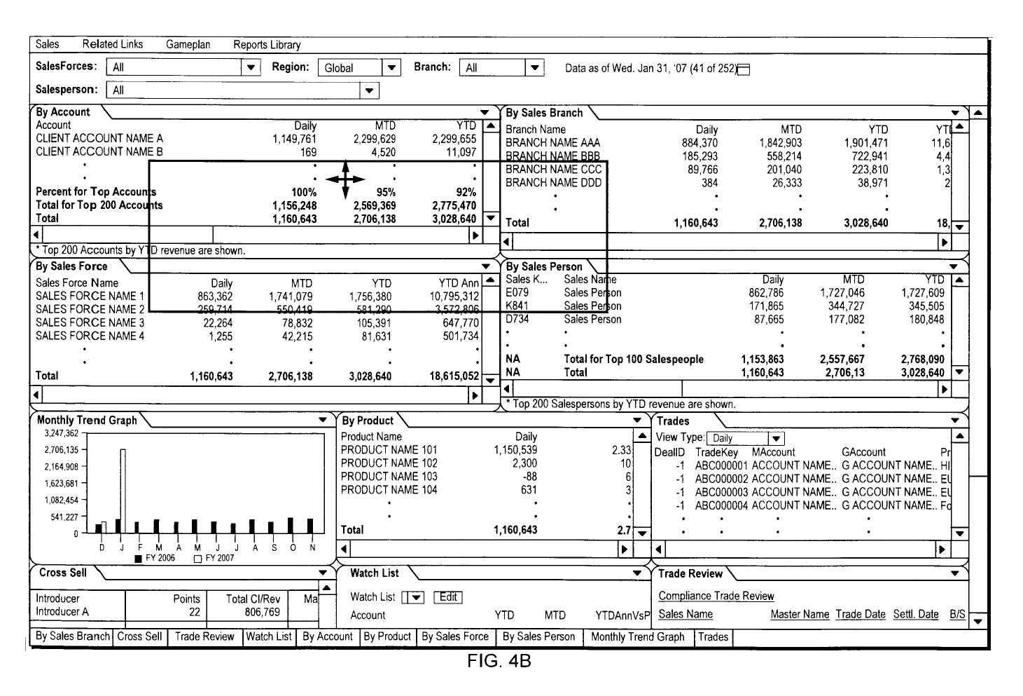

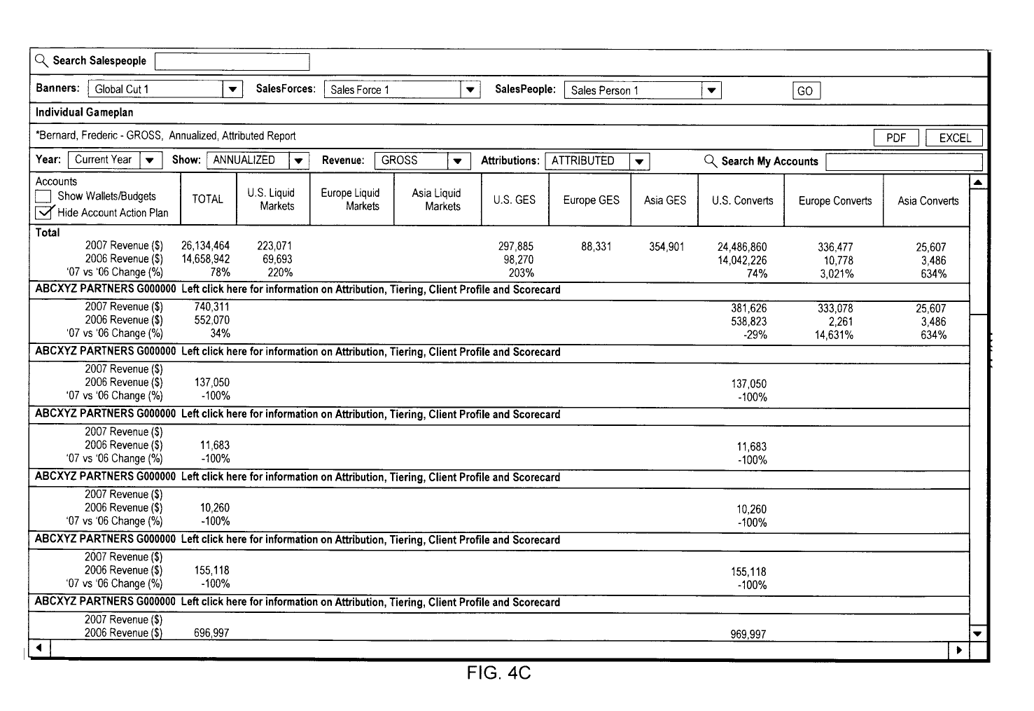

An exemplary sales portal is described as follows. In this example, sales portal is a consolidation of information that the sales force requires on a daily basis into a single dashboard combining economic details with CRM content and trading tools to help the sales force better manage their business. With reference to FIG. 4A, a screen illustrating an exemplary sales portal.

In one embodiment, the portal comprises several different types, each with differing content depending on the product and region (e.g., senior manager, sales/branch manager, team leader, sales person). While one or more default views of the portal may be established, such views may also be customized by each user. With reference to FIG. 4B, a user may personalize his portal by dragging and dropping portlets within the portal. The user may select from various portlets to be included in his personalized portal. The sales portal can used to compile and present salesperson metrics, thereby providing an effective way for managing revenue producers. A manager's ability to review a salesperson's performance is automated and updated on a daily/real time basis via the portal. By providing a manager with a transparent view of the client revenue associated with each sales desk, the manager is provided a simple means of measuring efficiency. Affording the salesperson access to that same view allows employees and managers to synchronize goals and discuss historical performance and trending metrics in a contextualized, meaningful way.

In order to accomplish this, the portal requires a salesperson to forecast a budget and holds him to that standard. The employee's success in meeting set objectives drives compensation and determines future management decisions in most organizations. On a day-to-day basis, the salesperson can view his budget forecast versus actual to track personal performance. Desk managers and senior management have rollup views of the same information. Another benefit of the portal's trending metrics is that it offers visibility into business transactions by customer. This functionality translates into powerful CRM information, as it alows traders and managers to target sales strategies and track customer relationships more efficiently. With reference to FIG. 4C, a screen showing a sale person's game plan is shown.

Within the portal, data from disparate data sources is aggregated. In particular, metrics are aggregated across different systems (e.g., client revenue, sales budget, expense, trading budget, risk, trading revenue, and non personal expense). Such metrics are normalized and aggregated.

Using the portal described herein, forecasting can be accomplished. The forecasting methodology uses a bespoke client coverage model (ACS—Attributed Coverage System) to maintain both generic client relationships and specific product revenue percent attribution. With this product level matrix, the forecasting can dynamically derive budget targets and opportunities and present those in line with the sales user's attributed sales revenues. Further various qualitative and quantitative sales metrics can be captured and managed, such as clients/sales budget targets, opportunity targets, client wallet, action points, opportunities and targets. Targeted profiling (i.e., based on product focus and responsibility) for sales coverage teams provide real-time direction and performance base-lines.

Layout personalization and portlet customization are two additional features portals described herein. In layout personalization, the user has the capability of rearranging the layout by dragging and dropping the portlets within the portal. For portlet customization, the user can choose which and how the columns are displayed within a portlet. In addition, each portlet has a set of common features such as export to Excel, PDF printing, sorting, portlet resizing, and column freezing & resizing. To accomplish the above referenced features, the portal architecture illustrated in FIG. 1B is used. With regard to databases 105, the database schema in apps database 104 is extended to store additional portlet properties (e.g., column label, column ordering, and column display). The personalization service 108 of application framework 102 is extended to include the portlet properties when communicating with the databases 105. With regard to server 101, each struts action class includes and maintains the additional portlet properties. In addition, the struts controller servlet maintains the current state of the portal. This is used in case the session timed out on the client browser. The user interface framework employs changes to each portlet in the registered components to allow users to customize which columns to order and display as well as how to label the columns. The JS Container 109 is configured to allow users to rearrange the layout by dragging and dropping the portlets within the portal.

Thus, a database is created which holds the users' attributes and entitlements. The users' attributes include name, login id, and location, by way of example. The users' entitlements tell the system which role(s) are associated with him and the user group to which he belongs. The database stores the default and customized properties of the portal and portlets. The properties of the portlet include, e.g., column name, column ordering, column visibility, and portlet dimension. The properties of the portal include, e.g., portal layout name, portlet location, and portlet display order. This display order is used to determine if the portlet is at the front or at the back in case of overlapping portlets. Additional tables are used to tie each user role to a set of portlets and a default portal layout. Once a user creates a personalized portal layout, he will have more than one layout available.

Further, a suite of reusable services is created to centralize all requests from the client to the database (i.e., the application framework as described elsewhere herein). The application framework is implemented in Java, in one embodiment. The personalization services, entitlement services, database services described previously expose business oriented functions and hide the technical details. The interaction between databases and these services is via JDBC.

Using the Java MVC Struts Framework, several components are created on the server (e.g., Personalizer Servlet, FOP Servlet, Excel Servlet, and Struts Controller Servlet). These server components comprise a model controller, which is a collection of server side classes. The main responsibility of these classes is to bridge the application framework and user interface framework. The Personalizer Servlet decides which services to use when the user saves the setting of the portal and portlets. The FOP Servlet provides a PDF feature of each portlet. The Excel Servlet provides the Excel features of each portlet. The Struts Controller Servlet maintains the state of both the portlets and the portal. Given that the user may refresh the data for the entire portal or for each individual portlet, knowing the state allows for the maintaining of the same latest setting on the screen.

JavaScript and Ajax are used create a user interface framework that standardizes and centralizes the portlet and portal functions. These functions include dragging and dropping of portlets, sorting inside the portlet, and column resizing of the portlet, by way of example. This framework not only enhances user's experience but also provides a library of client-side functionalities to be shared and reused by all portlets within the portal. Communication between the model controller and client browser is via http requests.

The forecasting methodology is now described in more detail, with reference to an example of forecasting that may be accomplished by a sales person who works in the equities group of a financial services company.

The first component is referred to as a Global Sales System (“GSS”), in which client and sales data, taken from disparate sources, are aggregated. Data from disparate sources are exported, transformed and loaded into a central reporting repository. Qualitative and quantitative data sources include, by way of example, client/sales budget information (e.g., the sales target budgeted for a given sales person for a given client), tiering (e.g., focus accounts identified by the financial services firm based on the firm's global sales strategies), sales credits (e.g., the amount of credit a sales person has received for a sale, from various order and execution systems), travel/expense (e.g., how much a sales person has spent working a client), client meetings (e.g., when client meetings have taken place and are to take place in the future), and market data (e.g., product prices, client street volumes, credit ratings). Other types of data from additional data sources may be used within the scope of the present invention. In accordance with the transformation process, the source data is extracted and the data metrics are converted to standardized identifiers (e.g., client, sales representative, product, region, denomination). For example, EU trades are sourced directly from a trade system. The trade data uses its own identifiers for client/counterparty, products and sales. The non-standard identifiers make it incompatible with unified reporting. The transformation process converts the extracted data to universal client, product and sales identifiers from which it can be loaded into the repository. This normalized data can then be aligned with other normalized data (e.g., trade feeds, qualitative data, and budget information) to provide standardized client/sales data, thereby allowing for meaningful comparison among the data taken from the various sources.

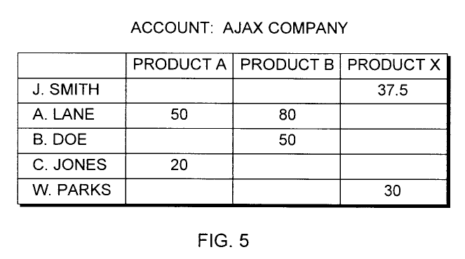

The next component is referred to at the Attributed Coverage System (“ACS”), in which sales credit allocation and product assignment is accomplished. In particular, sales credits may be allocated via a bespoke coverage system (i.e., ACS). The coverage system defines client/product level relationships and attribution proportions for sales credits for sales individuals. For example, with reference to FIG. 5, a matrix generated in accordance with the ACS is illustrated for a given client. The y-axis identifies the sales people covering the account. The x-axis identifies the products involved with the account. Where they intersect represents the attribution percentage. For example, sales person John Smith covers Product X with 37.5% attribution for client Acme Inc.

Using information from the GSS and the ACS, individual sales strategies are dynamically created, in real-time, for the sales people. The strategies are derived by combining the generic user profile information (e.g., the user's division, location, reporting hierarchy, and seniority), client/sales data from the GSS, and sales credit allocation/product assignment from the ACS. The sales-strategy yielded provides targets around, for example, client focus (i.e., what clients the sales person should focus on), product focus (i.e., what products the sales person should focus on), market focus (what market the sales person should focus on), budget allocation (how much money should be allocated to this strategy), opportunity target (identification of potential new opportunities for a given client/revenue targets), and/or actions/initiatives (action item that should be taken). Strategies can be produced for a given product, client, sales individual, sales-force, region, branch and firm, in the preferred embodiment. For example, from the ACS system we know sales person A has a 20% attribution of Product G trades for Client X. Integrating this information with the volumes traded for a given product for the Client X, it can be determined, proportionally, what volume is attributed to the sales person; the client can then be flagged for focus when combined with client budget targets and client tiering information. Additionally, individual budgets (i.e., budgets allocated (derived from attribution) for individuals) can be dynamically set and actions/initiatives automatically assigned in certain pre-determined conditions.

For example, from the ACS system it is known that sales person A has a 20% attribution of Product G sales credits for Client X. Applying this attribution matrix to the sales credit data feeds, the attributed sales credits for each sales-person can be determined. This information, when combined with client tiering information, budget targets and actions/initiatives can be used to dynamically generate a sales strategy for the individual with individualized opportunities, performance measures, client/sales budget targets and client/product focus.

The portal described herein (see, e.g., FIG. 4C) can then be used to display this information in a unified way. The content of the portal (i.e., the layout, metrics and entitlements) is dynamically created, driven from the sales user's strategy. The portal components (i.e., portlets) are automatically tailored to highlight relevant clients, metrics, targets and performance for the sales person. For example, sales reporting components within the portal are automatically tailored to focus and profile the user's covered clients. The reporting integrates individualized budget targets (derived from attribution) and highlights account focus based on tiering strategies (i.e., firm client focus lists). Based on the users/product client focus and trade activity, action points are automatically assigned and targets dynamically adjusted. Profiling is also driven by the user's profile, such as sales role and seniority (e.g., managers have the ability to see aggregated views of their sales-forces and see macro client/sales strategies, targets and actions).

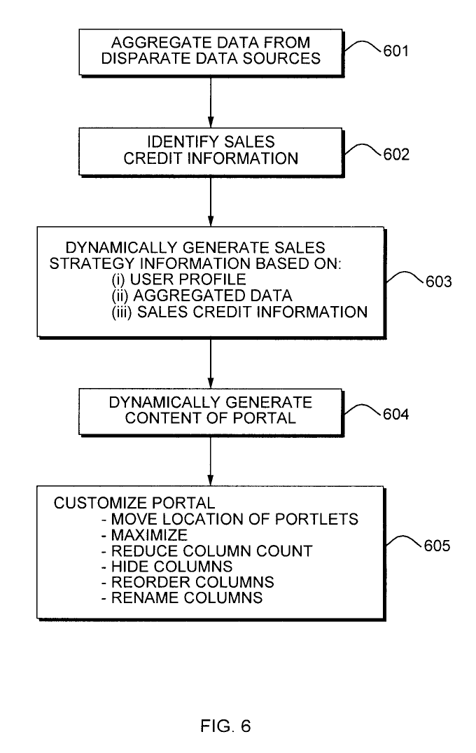

With reference to FIG. 6, an exemplary method for displaying sales information to a sales person via a portal is illustrated. Data from a plurality of disparate data sources is aggregated in step 601. Sales credit information attributable to the sales person for his clients, and for products associated with each such client, is identified in step 602. Based on (i) user profile information for the sales person, (ii) at least some of the aggregated data, and (iii) at least some of the identified sales credit information, sales strategy information is dynamically generated for the sales person, in step 603. Content of the portal is dynamically generated based on the sales strategy information, in step 604. In some embodiments, step 601 includes normalizing data from at least two of the plurality of disparate data sources and combining the normalized data.

In some embodiments, in step 605, the sales person is allowed to customize one or more of the one or more portlets within a browser in which the portal is displayed. This customization may include (a) moving one or more of the one or more portlets to another location of the portal; (b) maximizing one or more of the one or more portlets within the portal; and/or (c) for portlets comprising a plurality of columns of data (i) reducing a count of the plurality of columns of data; (ii) hiding one or more of the plurality of columns of data; (iii) reordering one or more of the plurality of columns of data; and (iv) renaming one or more of the plurality of columns of data. The user profile information is associated with a default portal layout and a default set of one or more portlets associated with the default portal layout. If customized, the user profile information is associated with a customized portal layout and a customized set of one or more portlets.

One or more of the foregoing steps may be performed by software running on a computer processing apparatus.

The present invention is intended to embrace all alternatives, modifications and variances that fall within the scope of the appended claims.

What is claimed is:

1. A method comprising:
aggregating data from a plurality of data sources;
identifying sales credit information attributable to a sales person for one or more clients of the sales person, and for one or more products associated with each of one or more of the one or more clients;
based on (i) user profile information for a user, (ii) at least some of the aggregated data, and (iii) at least some of the identified sales credit information, generating sales strategy information for the sales person;
generating content of a portal comprising sales information based on the sales strategy information; and
displaying the content via the portal.

2. The method of claim 1 wherein the aggregating step comprises:
normalizing data from at least two of the plurality of data sources; and
combining the normalized data.

3. The method of claim 1, wherein the portal comprises one or more portlets, further comprising:
allowing the user to customize one or more of the one or more portlets within a browser window in which the portal is displayed.

4. The method of claim 1, wherein the portal comprises one or more portlets, further comprising:
allowing the user to customize one or more of the one or more portlets by one or more of (a) moving one or more of the one or more portlets to another location of the portal; (b) maximizing one or more of the one or more portlets within the portal; and (c) for portlets comprising a plurality of columns of data (i) changing a count of the plurality of columns of data; (ii) hiding one or more of the plurality of columns of data; (iii) reordering one or more of the plurality of columns of data; and (iv) renaming one or more of the plurality of columns of data.

5. The method of claim 1 wherein the user profile information is associated with a default portal layout and a default set of one or more portlets associated with the default portal layout.

6. The method of claim 1 wherein the user profile information is associated with a customized portal layout and a customized set of one or more portlets associated with the customized portal layout.

7. A computer readable medium comprising instructions which, when executed on a processor, perform a method comprising:
aggregating data from a plurality of data sources;
identifying sales credit information attributable to a sales person for one or more clients of the sales person, and for one or more products associated with each of one or more of the one or more clients;
based on (i) user profile information for a user, (ii) at least some of the aggregated data, and (iii) at least some of the identified sales credit information, generating sales strategy information for the sales person;
generating content of a portal comprising sales information based on the sales strategy information; and
displaying the content via the portal.

8. The computer readable medium of claim 7 wherein the aggregating step comprises:
normalizing data from at least two of the plurality of data sources; and
combining the normalized data.

9. The computer readable medium of claim 7, wherein the portal comprises one or more portlets; further comprising:
allowing the user to customize one or more of the one or more portlets within a browser window in which the portal is displayed.

10. The computer readable medium of claim 7, wherein the portal comprises one or more portlets, further comprising:
allowing the user to customize one or more of the one or more portlets by one or more of (a) moving one or more of the one or more portlets to another location in the portal; (b) maximizing one or more of the one or more portlets within the portal; and (c) for portlets comprising a plurality of columns of data (i) changing a count of the plurality of columns of data; (ii) hiding one or more of the plurality of columns of data; (iii) reordering one or more of the plurality of columns of data; and (iv) renaming one or more of the plurality of columns of data.

11. The computer readable medium of claim 7 wherein the user profile information is associated with a default portal layout and a default set of one or more portlets associated with the default portal layout.

12. The computer readable medium of claim 7 wherein the user profile information is associated with a customized portal layout and a customized set of one or more portlets associated with the default portal layout.

13. A system comprising:
a data aggregation component for aggregating data from a plurality of data sources;
an attributed coverage component for identifying sales credit information attributable to a sales person for one or more clients of the sales person, and for one or more products associated with each of one or more of the one or more clients;
a processing component for generating sales strategy information for the sales person based on (i) user profile information for a user, (ii) at least some of the aggregated data, and (iii) at least some of the identified sales credit information;
a portal content generation component for generating content of a portal comprising sales information based on the sales strategy information; and
a portal component for displaying the sales information.

14. The system of claim 13 wherein aggregating comprises:
normalizing data from at least two of the plurality of data sources; and
combining the normalized data.

15. The system of claim 13, wherein the portal comprises one or more portlets, wherein the user customizes one or more of the one or more portlets within a browser window in which the portal is displayed.

16. The system of claim 13, wherein the portal comprises one or more portlets, wherein the user customizes one or more of the one or more portlets by one or more of (a) moving one or more of the one or more portlets to another location in the portal; (b) maximizing one or more of the one or more portlets within the portal; and (c) for portlets comprising a plurality of columns of data (i) changing a count of the plurality of columns of data; (ii) hiding one or more of the plurality of columns of data; (iii) reordering one or more of the plurality of columns of data; and (iv) renaming one or more of the plurality of columns of data.

17. The system claim 13 wherein the user profile information is associated with a default portal layout and a default set of one or more portlets associated with the default portal layout.

18. The system claim 13 wherein the user profile information is associated with a customized portal layout and a customized set of one or more portlets associated with the default portal layout.
